(19) United States
(12) Patent Application Publication
(10) Pub. No.: US 2013/0086170 A1
(43) Pub. Date: Apr. 4, 2013

(54) METHOD AND SYSTEM TO IDENTIFY CONTENT TASTEMAKERS

(71) Applicants: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US)

(72) Inventors: Richard Skelton, Los Angeles, CA (US); Jason Rosenthal, Los Angeles, CA (US); Eric Wilson, Los Angeles, CA (US); Patrick Kennedy, West Hollywood, CA (US); Stephanie L. Grossman, Santa Monica, CA (US)

(73) Assignee: Sidebar, Inc., Redondo Beach, CA (US)

(21) Appl. No.: 13/633,052

(22) Filed: Oct. 1, 2012

Related U.S. Application Data
(60) Provisional application No. 61/541,025, filed on Sep. 29, 2011.

(51) Int. Cl. G06F 15/16

(52) U.S. Cl. 709/204

(57) ABSTRACT

According to exemplary embodiments, the present invention provides a method for presenting content information to a user. The method includes identifying by a processor content associated with an influential content consumer. The method also includes providing the content information of the content associated with the influential content consumer for display to the user. A system for presenting content information to a user is provided. The system includes a social network database and an available content index comprising data concerning available content. The system also includes a recommendation engine adapted to access the social network database and identify an influential content consumer. The recommendation engine is further adapted to apply content data associated with the influential content consumer to the available content index to provide the content information to the user. A non-transitory computer readable medium having recorded thereon a program is provided. The program when executed causes a computer to perform a method for presenting content information.

### CROSS REFERENCE TO RELATED APPLICATIONS

This Non-Provisional U.S. Patent Application claims the benefit of U.S. Provisional Patent Application Ser. No. 61/541,025 filed on Sep. 29, 2011, entitled “Method to Identify Users that Increase Consumption within Social Networks to Influence Recommendations”, which is hereby incorporated by reference herein in its entirety.

### FIELD OF THE INVENTION

The present invention relates generally to content presentation, and in particular relates to systems and methods for recommending content to a user based on information from a social network.

### BACKGROUND

Content is often presented to a user in alphabetical order, chronological order of broadcast or recording, or alternatively in sequential order of presentation. Alternatively, content may be presented in channels to a user for selection.

Some content becomes popular either through the influence of influential content consumers (also referred to as tastemakers), and/or influential content consumer are persons that are able to identify content that will become popular.

### SUMMARY OF THE INVENTION

According to exemplary embodiments, the present invention provides a method for presenting content information to a user. The method includes identifying by a processor content associated with a tastemaker. The method also includes providing the content information of the content associated with the tastemaker for display to the user.

A system for presenting content information to a user is provided. The system includes a social network database and an available content index comprising data concerning available content. The system also includes a recommendation engine adapted to access the social network database and identify a tastemaker. The recommendation engine is further adapted to apply content data associated with the tastemaker to the available content index to provide the content information to the user.

A non-transitory computer readable medium having recorded thereon a program is provided. The program when executed causes a computer to perform a method for presenting content information to a user. The method includes applying a filter selection to metadata of content associated with a tastemaker based on an area of competence of the tastemaker, and identifying the content associated with the tastemaker within the area of competence. The method also includes providing the content information of the content within the area of competence for display to the user.

These and other advantages of the present invention will be apparent when reference is made to the accompanying drawings and the following description.

### BRIEF DESCRIPTION OF THE DRAWINGS

FIG. 1 illustrates an exemplary system for practicing aspects of the present technology.

FIGS. 2A and 2B illustrate an exemplary device and an exemplary system including an exemplary device for practicing aspects of the present technology.

FIG. 3 is a flow chart illustrating an exemplary method for practicing aspects of the present technology.

FIG. 4 illustrates a graphical user interface for interacting with an exemplary device for practicing aspects of the present technology.

FIG. 5 an exemplary computing device that may be used to implement an embodiment of the present technology.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology relates generally to content organization and delivery systems. More specifically, the present invention provides a system and method for identifying tastemakers and presenting, to a user, content information associated with a tastemaker. Though most of the following examples relate to video content, the invention is applicable to any content, for instance audio and/or written content.

Systems, methods and media are provided herein for identifying person(s) that influence the consumption of content within social network services and applications for set top boxes, computers, tablets, mobile phones and other devices.

A social network (also referred to as an SN) service may be an online service, platform, or site that focuses on building and reflecting social networks or social relations among people, who, for example, share interests and/or activities. An SN service may include a representation of each user (e.g., a profile), his/her social links, and a variety of additional services (e.g., games, content sharing, etc.). SN services may, for example, be web based and provide means for users to interact over the Internet, such as e-mail and instant messaging. Examples of SN services include Myspace™, LinkedIn™, Facebook™, Google+™, Badoo™, Renren™, and the like.

User-generated content (UGC) has become an important element to the experience of participating in SN services and applications. Depending on the capabilities of a particular SN service, users may be able to voice opinions or express their affinity for, distaste for, and/or indifference to a variety of subject matter in a multitude of ways. For instance, a user may post personal commentary about a subject, post direct links to (editorial) content from around the web, submit ratings about content, submit recommendations of content, and/or reviews of content. For example, users may post a rating or recommendation, such as “Liked” or “+1”ed, of content from anywhere on the internet.

As SNs continue to focus their efforts around entertainment and commerce, explicit user recommendations may increase in importance and influence. Just as the role of the individual blogger has been elevated to a legitimate source of editorial and news coverage over the past decade, the availability of a forum to submit recommendations to users throughout an entire SN service may enable some SN users to become legitimate purveyors of valued opinion on various forms of content, i.e., tastemakers.

Content may include, but is not limited to: a TV show, documentary, news program, performance, movie, web video clip, game or other form of entertainment content. Content may also include a news story, blog post, message board post, website link, or other form of informational content. Content may also include user-generated content such as a user-made video, photo, photo gallery, story, news, editorial or opinions about news, websites, blogs, editorials, stories, photos, and the like. Content may, for example, be accessible through a content provider, or from a personal collection of stored content on a computer, connected device, digital content service, and the like. Content may also be digitally encoded and optionally compressed video and audio (e.g., MPEG-1, MPEG-2, H.264, VC-2, AAC, AC-3, MP3, etc.).

These trends raise questions. For instance, how do users find out about where the value lies within a mass of explicit, user-generated recommendations? Recommendations, like all opinions, are subjective in nature. How can the effectiveness of recommendations be derived and presented to a user base? Additionally, how can knowledge about the quality of the source of user-generated recommendations be leveraged to provide an enhanced experience for an entire user base?

Depending on the paradigms employed by the SN service, users may have the ability to, for example, to “follow” certain users or invite or add them as a “friend”. The process of following or friending allows an SN user to gain access to the activity stream of UGC generated by the followed user. In the context of entertainment-centric SNs, explicit user-generated recommendations may be included in this activity stream. For such services, the ability to make a recommendation does not require the ‘editorialist’ to hold any credentials that verify the quality of their selections. The ability to identify users whose recommendations may drive consumption of content, and whose recommendations significantly propagate throughout all networked users, provides great value to users of an SN, as well as content providers. These identified ‘tastemakers’ inform end users or proprietors of content about the content and its popularity or prospective popularity, and are consequently individuals within a SN whose opinions are highly valued.

Being a tastemaker implies an impact on the actions of a community of people. This may manifest in the following ways. An in-network tastemaker may be someone specifically residing within a user's network of followers or friends that has explicitly influenced the perception of content by others in their local network. A global tastemaker may be someone that has explicitly influenced the perception of content across a broad range of users within an SN service or application.

The concept of ‘content perception influence’ is defined as a measure of how users are affected by the receipt of content recommendations based on subsequent related actions taken upon that content, and extends to include many things. Actual content consumption includes when a user watches, purchases, and/or downloads an item that was previously recommended by another individual. Reciprocally expressed affinity includes when a user positively rates an item that was previously recommended by another individual. Recommendation confirmation includes when a user subsequently recommends or shares an item that was previously recommended to them by another individual.

By tracking the occurrence and manner of subsequent user-content interactions that are relevant to these concepts around ‘content perception influence’, tastemakers may be derived and presented to users in a variety of ways. Tastemakers may be presented as recommended individuals to follow, may be presented as ‘featured’ profiles of a service, and/or may be provided special benefits or other incentives. Virtual commendations such as medals or badges may be awarded to a tastemaker, and local network tastemakers (among your personal network) may be presented on user profile pages.

The expression of tastemakers may be segmented by a topic of ‘expertise’. Users who are particularly effective at recommending items concerning a particular subject matter or matters may be identified as tastemakers for this respective topic, type, or category of content.

In addition to the identification and presentation of tastemakers to end-users, this concept may also be used when predicting relevant content for users through use of a recommendation engine. This engine, which may exist in a server environment or on a remote device, takes in all previous viewing behaviors exhibited by a user and renders them into a data store. This recommendation/personalization engine applies algorithms to the stored user behavioral data, as well as content meta-data also rendered in a data store, in order to understand each individual user's content tastes/preferences. Based on this calculated understanding of the user, the recommendation engine may offer predictions or recommendations about the content the users are likely to consume. Multiple variables may be applied in a statistical model in order to render predictions or, more specifically, the content a user is likely to consume. Examples of such variables may be a particular time of the day and/or day of the week, the length of time they have available to watch content at a particular time of day and/or day of the week, and their mood at a particular time of day and/or day of the week.

Items suggested by tastemakers, whether they are ‘in-network’ or ‘global’, may be used to influence recommendations using the following approaches. A tastemaker suggested content may simply be appended to the list of engine derived recommendations as user-generated editorial. The fact that a particular item has been recommended by an identified tastemaker may be reflected by the association of a weight value to that item. This assigned weight value, in turn, may affect the determination of the recommendation engine, thus increasing the likelihood of the item's inclusion with subsequently derived recommendations.

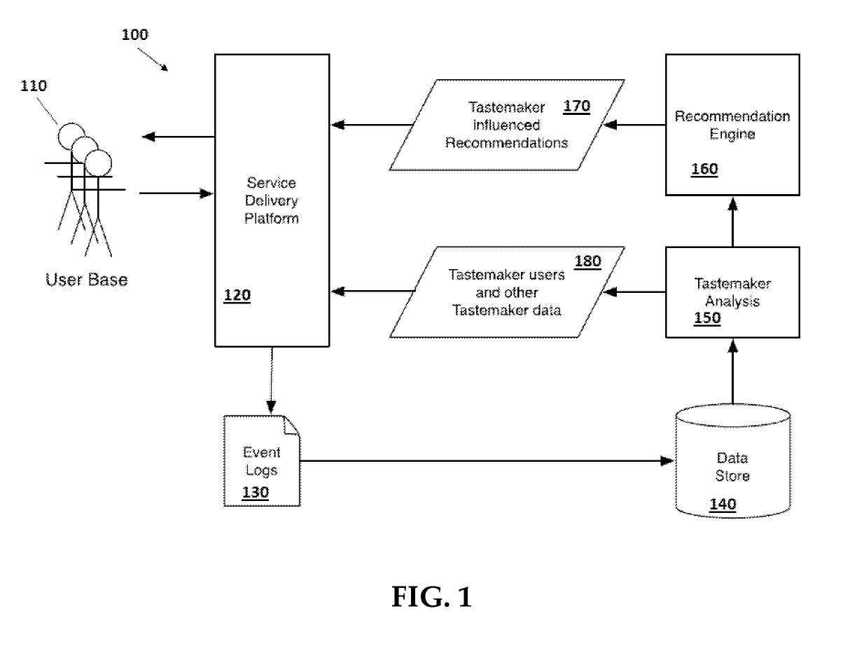

FIG. 1 illustrates an exemplary data driven process 100 from which a tastemaker and associated data may be derived and used within a service delivery environment. Users 110 represent a network of users (also referred to as a user base) that provide the audience for a target service. Users 110 engage via inputs with a given service delivery platform 120 (SDP 120) of the target service, thereby generating events that may be captured and stored. SDP 120 provides the user interface (UI) and technology to support the actions and experience of the target service. Event logs 130 are generated by SDP 120 and capture usage data. Event logs 130 may contain all data required to reflect the content perception and influence for all users of a service as well as all engaged content. Event logs 130 are sent to a data store 140. Relevant usage data may be retrieved within data driven process 100 to perform a tastemaker analysis 150 to identify a tastemaker and derive other specified aspects of the described tastemaker concept. Tastemaker analysis 150 may output tastemaker data to a recommendation engine 160 to provide recommendations to target users for content or item personalization, and/or to change or append to search results by the target user.

Recommendation engine 160 may output tastemaker influenced recommendations 170, that may be generated based on user behavior and influenced by any relevant aspects of the described tastemaker concept. Tastemaker influenced recommendations 170 may be sent to SDP 120 for presentation to one, some, or all users 110. Usage data used in tastemaker analysis 150 may be output to derive tastemaker users and other tastemaker data 180. For instance, tastemaker users and other tastemaker data 180 may include identification of a global or in-network tastemaker, and/or an area or areas of competence for the tastemaker. Tastemaker users and other tastemaker data 180 may be sent to SDP 120 for presentation to one, some, or all users 110. In this manner, tastemaker users and related information, and tastemaker-affected recommendations may be displayed to the end-user via the target service user interface.

The system may include a display module adapted to display the content information. The recommendation engine may be further adapted to form a hierarchical presentation of the content information. The hierarchical presentation may indicate a degree of association between the content and the tastemaker. The system may include a search engine providing search results based on a query from the user. The content information may be provided with the search results.

The system may include an area of competence filter. The area of competence filter may be applied to metadata of the content based on an area of competence of the tastemaker to highlight the content information of the content within the area of competence. The system may include a tastemaker identifier module adapted to recommend the tastemaker to the user with the area of competence of the tastemaker. The system may include a tastemaker recommender module adapted to recommend the tastemaker to the user. The system may include a viewing history database recording data related to content consumed by at least one of the user and the tastemaker.

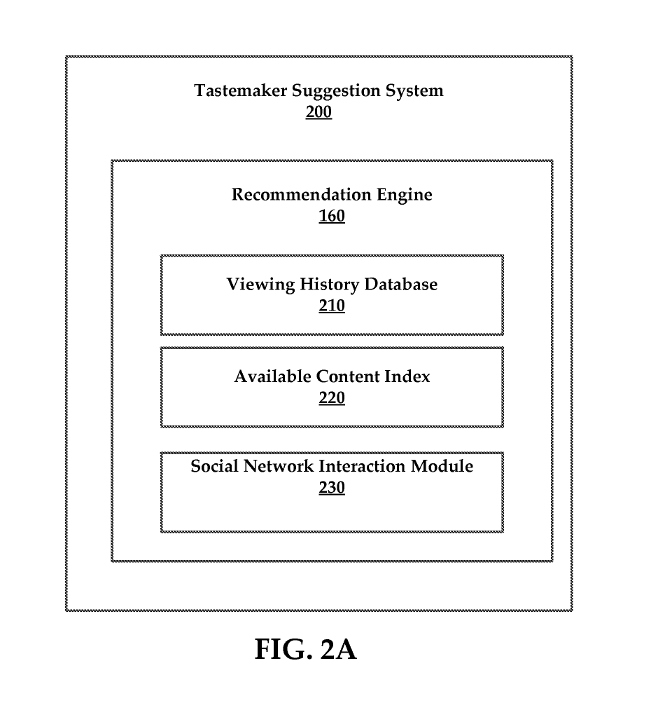

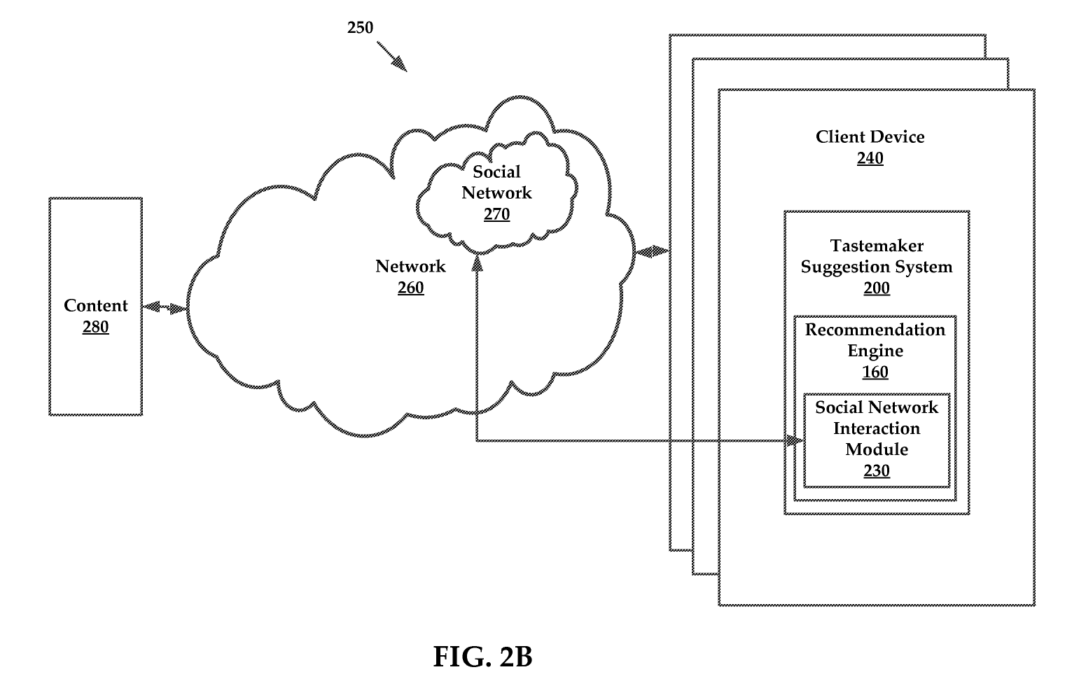

FIG. 2A illustrates an exemplary tastemaker suggestion system 200 for practicing aspects of the present technology. Tastemaker suggestion system 200 includes recommendation engine 160, which in turn includes, viewing history database 210, available content index 220 and social network interaction module 230. The system may include a display module adapted to receive content suggestions or recommendations, tastemaker identifications, and/or search results enhanced with tastemaker generated suggestions and provide these to a user, via a tablet, smartphone or other display, including the display used to deliver the content. Tastemaker suggestion system 200 may include a user input module adapted to receive a user input, or example a filter selection. The filter selection may be a topic of interest to the user for content consumption, and may result in a different tastemaker identification and consequently different content suggestions and/or recommendations. Alternatively, the filter selection may be based on content consumption data of the user.

FIG. 2B illustrates an exemplary system 250 including tastemaker suggestion system 200 for practicing aspects of the present technology. In FIG. 2B, tastemaker suggestion system 200 is software or firmware operating on client device 240. Client device 240 may be a television, monitor, computer, tablet computer, smartphone, or any other device having a processor and a display. In alternative exemplary embodiments, the display may be separate from client device 240, and/or tastemaker suggestion system 200 may operate remotely in a cloud-based environment. Tastemaker suggestion system 200 includes recommendation engine 160. Client device 240 may communicate over network 260 to access content 280. Content usage of content 280 of both users and tastemakers may be stored locally in client device 240 or in a cloud-based system in network 260 or in social network 270. Social network 270 may exist within network 260, or alternatively may be separate from network 260, and may be accessed by social network interaction module 230.

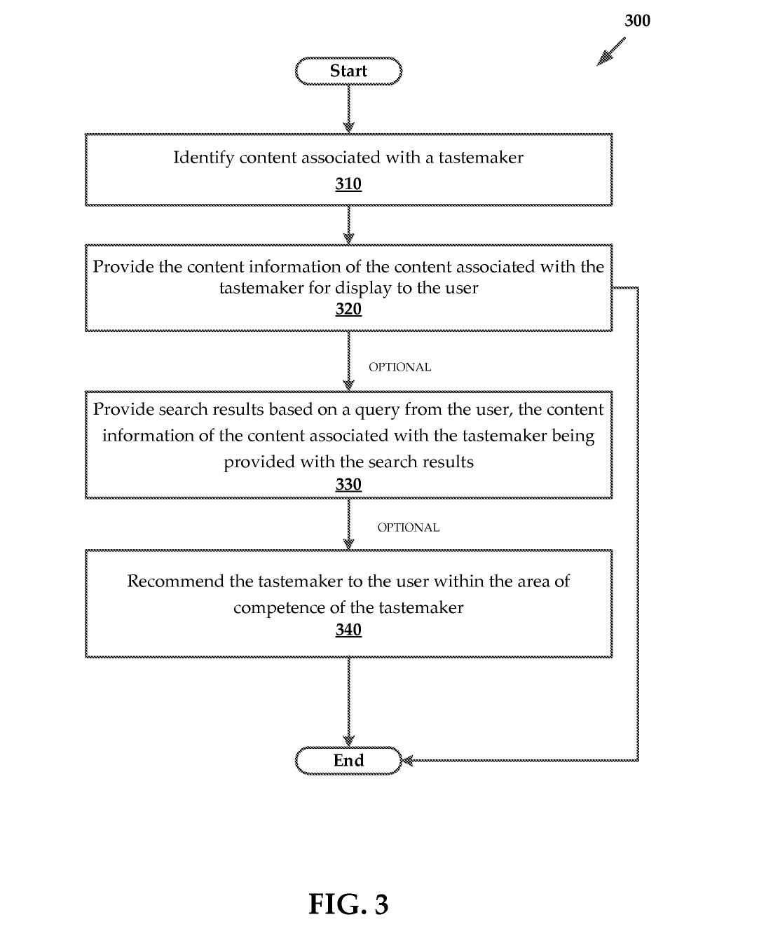

FIG. 3 illustrates method 300 for identifying a tastemaker of content within a social network. Method 300 starts at a start oval and proceeds to operation 310, which indicates to identify content associated with a tastemaker. From operation 310, the flow proceeds to operation 320, which indicates to provide the content information of the content associated with the tastemaker for display to the user. From operation 320, the flow may proceed to an end oval. Optionally, from operation 320, the flow may proceed to operation 330, which indicates to provide search results based on a query from the user. The content information of the content associated with the tastemaker may be provided with the search results. From operation 330, the flow optionally proceeds to operation 340, which indicates to recommend the tastemaker to the user within the area of competence of the tastemaker. From operation 340, the flow proceeds to an end oval.

In method 300, a filter selection may be a historical analysis of a user's past preferences, and the historical analysis may be determined by a recommendation engine based on content consumption data of the user. The available content may include broadcast television, cable television, streaming video, audio content, and DVR-accessible video. The hierarchical presentation of the available content may maximize a likelihood of a user preference for content presented earlier in the hierarchical presentation.

In method 300, the providing of the content information may include forming a hierarchical presentation of the content information. The hierarchical presentation may indicate a degree of association between the content and the tastemaker.

Method 300 may include providing search results based on a query from the user. The content information of the content may be associated with the tastemaker is provided with the search results. The identifying operation may include applying a filter selection to metadata of the content based on an area of competence of the tastemaker to highlight the content information of the content within the area of competence. The method may include recommending the tastemaker to the user with the area of competence of the tastemaker. The method may include recommending the tastemaker to the user. The tastemaker may be in a network of the user, or alternatively, may be presented to the user as a global tastemaker. The method may include identifying the tastemaker to the user, and enabling the user to obtain additional content information associated with the tastemaker.

Method 300 may include identifying the tastemaker based a first correspondence between a content consumption of the tastemaker and identified popular content, a second correspondence between a content grade by the tastemaker and the identified popular content, and/or a third correspondence between a recommendation by the tastemaker and the identified popular content.

Method 300 may include recommending the tastemaker to a user based on a first correspondence between a content consumption of the tastemaker and a content consumption of the user, a second correspondence between a content grade by the tastemaker and the content consumption of the user, and a third correspondence between the content consumption of the tastemaker and a content grade by the user. Alternatively, the method may include recommending the tastemaker to a user based on a fourth correspondence between the content grade by the tastemaker and the content grade by the user, a fifth correspondence between the content consumption of the tastemaker and a content recommendation by the user, and a sixth correspondence between the content grade by the tastemaker and the content recommendation by the user. Alternatively, the method may include recommending the tastemaker to a user based on a seventh correspondence between a content recommendation by the tastemaker and the content grade by the user, an eighth correspondence between the content recommendation by the tastemaker and the content recommendation by the user, and a ninth correspondence between the content recommendation by the tastemaker and the content consumption by the user.

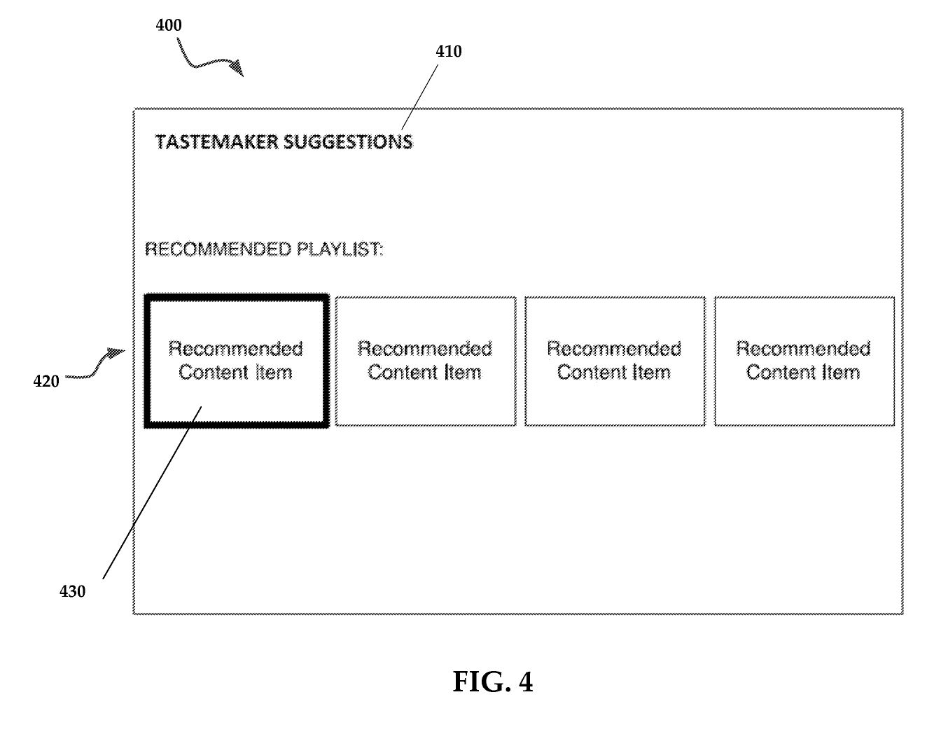

FIG. 4 is a graphical user interface of a tastemaker suggestion interface 400. Tastemaker suggestion interface 400 in FIG. 4 may be displayed to a user on any appropriate display device, and may be displayed in response to a query, periodically, or automatically. Title 410 of tastemaker suggestion interface 400 may include an identification of a tastemaker, and/or an area of competence for the tastemaker. Recommended play list 420 may display rank ordered content generated based on a tastemaker's content consumption, user grading, and/or recommendations. Additionally, or alternatively, recommended play list 420 may be displayed in response to a user query. Selected content item 430 within recommended play list 420 is the top and/or the first item in the hierarchical list, and/or is the item selected that may be instantly watched or otherwise consumed by a further input by the user. In alternative exemplary embodiments, the content represented in recommended play list 420 may automatically be presented to the user in hierarchical order unless paused or skipped. Additionally, or alternatively, tastemaker suggestion interface 400 may provide for user input to select a specific tastemaker among a group of tastemakers, to select an area of competence for filtering all possible tastemakers, and/or to select a genre and/or show style (e.g., sitcom, talk show, drama) to be applied to the tastemaker suggestions and/or recommendations.

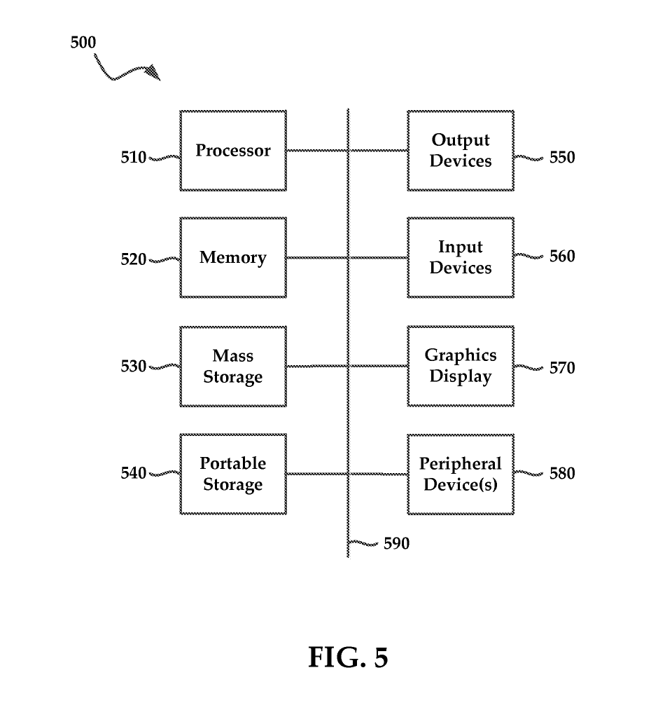

FIG. 5 illustrates an exemplary computing system 500 that may be used to implement an embodiment of the present technology. Data driven process 100 and/or client device 240 may include one or more of the components of computing system 500, and/or computing system 500 may be used to perform method 300 of FIG. 3. The computing system 500 of FIG. 5 includes one or more processors 510 and memory 520. Memory 520 stores, in part, instructions and data for execution by the one or more processors 510. Memory 520 can store the executable code when the computing system 500 is in operation. The computing system 500 of FIG. 5 may further include a mass storage 530, portable storage 540, output devices 550, user input devices 560, a graphics display 570, and other peripheral device(s) 580.

The components shown in FIG. 5 are depicted as being connected via a single bus 590. The components may be connected through one or more data transport means. The one or more processor 510 and memory 520 may be connected via a local microprocessor bus, and the mass storage 530, peripheral device(s) 580, portable storage 540, and graphics display 570 may be connected via one or more input/output (I/O) buses.

Mass storage 530, which may be implemented with a magnetic disk drive or an optical disk drive, is a non-volatile storage device for storing data and instructions for use by processor 510. Mass storage 530 can store the system software for implementing embodiments of the present technology for purposes of loading that software into memory 520.

Portable storage 540 operate in conjunction with a portable non-volatile storage medium, such as a floppy disk, compact disk or digital video disc, to input and output data and code to and from the computing system 500 of FIG. 5. The system software for implementing embodiments of the present technology may be stored on such a portable medium and input to the computing system 500 via the portable storage 540.

Input devices 560 provide a portion of a user interface. Input devices 560 may include an alphanumeric keypad, such as a keyboard, for inputting alphanumeric and other information, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Graphics display 570 may include a liquid crystal display (LCD) or other suitable display device. Graphics display 570 receives textual and graphical information, and processes the information for output to the display device.

Peripherals device(s) 580 may include any type of computer support device to add additional functionality to the computing system. Peripheral device(s) 580 may include a modem or a router.

The components contained in the computing system 500 of FIG. 5 are those typically found in computing systems that may be suitable for use with embodiments of the present technology and are intended to represent a broad category of such computer components that are well known in the art. Thus, the computing system 500 of FIG. 5 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A method for presenting content information to a user, comprising:
identifying by a processor content associated with an influential content consumer; and
providing the content information of the content associated with the influential content consumer for display to the user.

2. The method of claim 1, wherein the providing of the content information further comprises forming a hierarchical presentation of the content information, the hierarchical presentation indicating a degree of association between the content and the influential content consumer.

3. The method of claim 1, further comprising providing search results based on a query from the user;
wherein the content information of the content associated with the influential content consumer is provided with the search results.

4. The method of claim 1, wherein the identifying operation further comprises applying a filter selection to metadata of the content based on an area of competence of the influential content consumer to highlight the content information of the content within the area of competence.

5. The method of claim 4, further comprising recommending the influential content consumer to the user with the area of competence of the influential content consumer.

6. The method of claim 1, further comprising recommending the influential content consumer to the user;
wherein the influential content consumer is in a network of the user.

7. The method of claim 1, further comprising recommending the influential content consumer to the user;
wherein the influential content consumer is presented to the user as a global influential content consumer.

8. The method of claim 1, further comprising:
identifying the influential content consumer to the user; and
enabling the user to obtain additional content information associated with the influential content consumer.

9. The method of claim 1, further comprising identifying the influential content consumer based on at least one of:
a first correspondence between a content consumption of the influential content consumer and identified popular content;
a second correspondence between a content grade by the influential content consumer and the identified popular content; and
a third correspondence between a recommendation by the influential content consumer and the identified popular content.

10. The method of claim 1, further comprising recommending the influential content consumer to a user based on at least one of:
a first correspondence between a content consumption of the influential content consumer and a content consumption of the user;
a second correspondence between a content grade by the influential content consumer and the content consumption of the user;
a third correspondence between the content consumption of the influential content consumer and a content grade by the user;
a fourth correspondence between the content grade by the influential content consumer and the content grade by the user;
a fifth correspondence between the content consumption of the influential content consumer and a content recommendation by the user;
a sixth correspondence between the content grade by the influential content consumer and the content recommendation by the user;
a seventh correspondence between a content recommendation by the influential content consumer and the content grade by the user;
an eighth correspondence between the content recommendation by the influential content consumer and the content recommendation by the user; and
a ninth correspondence between the content recommendation by the influential content consumer and the content consumption by the user.

11. A system for presenting content information to a user, comprising:
a social network database;
an available content index comprising data concerning available content; and
a recommendation engine adapted to access the social network database and identify an influential content consumer, the recommendation engine further adapted to apply content data associated with the influential content consumer to the available content index to provide the content information to the user.

12. The system of claim 10, wherein the recommendation engine is further adapted to form a hierarchical presentation of the content information, the hierarchical presentation indicating a degree of association between the content and the influential content consumer.

13. The system of claim 10, further comprising a search engine providing search results based on a query from the user;
wherein the content information is provided with the search results.

14. The system of claim 10, further comprising an area of competence filter, the area of competence filter being applied to metadata of the content based on an area of competence of the influential content consumer to highlight the content information of the content within the area of competence.

15. The system of claim 14, further comprising an influential content consumer identifier module adapted to recommend the influential content consumer to the user with the area of competence of the influential content consumer.

16. The system of claim 10, further comprising an influential content consumer recommender module adapted to recommend the influential content consumer to the user.

17. The system of claim 10, further comprising:
a viewing history database recording data related to content consumed by at least one of the user and the influential content consumer; and
a display module adapted to display the content information.

18. A non-transitory computer readable medium having recorded thereon a program, the program when executed causing a computer to perform a method, the method for presenting content information to a user, the method comprising:
applying a filter selection to metadata of content associated with an influential content consumer based on an area of competence of the influential content consumer;
identifying the content associated with the influential content consumer within the area of competence; and
providing the content information of the content within the area of competence for display to the user.

19. The non-transitory computer readable medium of claim 18, wherein the method further comprises identifying the influential content consumer based on at least one of:
a first correspondence between a content consumption of the influential content consumer and identified popular content;
a second correspondence between a content grade by the influential content consumer and the identified popular content; and
a third correspondence between a recommendation by the influential content consumer and the identified popular content.

20. The non-transitory computer readable medium of claim 18, wherein the method further comprises recommending the influential content consumer to a user based on at least one of:
a first correspondence between a content consumption of the influential content consumer and a content consumption of the user;
a second correspondence between a content grade by the influential content consumer and the content consumption of the user;
a third correspondence between the content consumption of the influential content consumer and a content grade by the user;
a fourth correspondence between the content grade by the influential content consumer and the content grade by the user;
a fifth correspondence between the content consumption of the influential content consumer and a content recommendation by the user;
a sixth correspondence between the content grade by the influential content consumer and the content recommendation by the user;
a seventh correspondence between a content recommendation by the influential content consumer and the content grade by the user;
an eighth correspondence between the content recommendation by the influential content consumer and the content recommendation by the user; and
a ninth correspondence between the content recommendation by the influential content consumer and the content consumption by the user.
